(19) United States
(12) Patent Application Publication
(10) Pub. No.: US 2018/0040303 A1
(43) Pub. Date: Feb. 8, 2018

(54) CUSTOMIZED IMAGE AS NOTIFICATION INDICATOR FOR APPLICATIONS IN A COMMUNICATIONS DEVICE

(71) Applicant: Futurewei Technologies, Inc., Plano, TX (US)

(72) Inventors: Zongfang Lin, Santa Clara, CA (US); Chen Tian, Union City, CA (US); Lawrence Davison, San Jose, CA (US); Reza Yazdani, Los Altos, CA (US); Ziang Hu, Union City, CA (US)

(73) Assignee: Futurewei Technologies, Inc., Plano, TX (US)

(21) Appl. No.: 15/226,531

(22) Filed: Aug. 2, 2016

(51) Int. Cl. G09G 5/377; G06T 3/60; G06T 11/60; H04L 12/58; G06T 13/80

(52) U.S. Cl. CPC G09G 5/377; H04L 51/24; G06T 13/80; G06T 11/60; G06T 3/60; G09G 2340/12; G09G 2320/10; G09G 2340/14

(57) ABSTRACT

The disclosure relates to technology for displaying a notification on a communication device. A communication device receives communications associated with a respective application operating on the communication device. The communication is identified to determine the sender by accessing contact information stored in storage and accessible by the communication device. The communications are filtered based on a prioritization level determined at least in part by information acquired when accessing the contact information, and the user of the communication device is notified of the filtered communications by displaying one or more customized images on a display of the communication device, with a customized image of the one or more customized images being representative of the sender such that the one or more customized images visually overlap with an icon corresponding to the application.

### BACKGROUND

In the current world of endless communication via email, voice mail, text and picture messages and social media, users of a communications device, such as a computer, smartphone or tablet, may become easily overwhelmed with a large number of communications received on their device(s). Thus, users may find themselves constantly checking their devices for incoming messages. For example, users may receive voice mails, emails and text communications from a large number of people regarding a variety of topics. In this case, the user's device may provide a notification such as a ring tone, vibration or visual alert or badge when such a communication is received. However, such notifications fail to provide the user with the ability to easily sort and filter through these communications, thereby consuming the user's time and ability to focus on other pressing issues.

### BRIEF SUMMARY

In one embodiment, there is a method for displaying a notification on a communication device, comprising receiving one or more communications associated with a respective one or more applications operating on the communication device; identifying one or more senders corresponding to the one or more communications by accessing contact information stored in storage and accessible by the communication device; filtering the one or more communications based on a prioritization level determined at least in part by information acquired when accessing the contact information; and notifying a user of the communication device of the filtered one or more communications by displaying one or more customized images on a display of the communication device, with a customized image of the one or more customized images being representative of the sender such that the one or more customized images visually overlap with an icon corresponding to the one or more applications.

In another embodiment, there is a communication device, comprising a non-transitory memory storage comprising instructions; a transceiver to receive one or more communications associated with a respective one or more applications operating on the communication device; a display including an indicator area notifying a user of the communication device when the one or more communications is received; and one or more processors in communication with the memory, the transceiver, and the display, wherein the one or more processors execute the instructions to: identify one or more senders corresponding to the one or more communications by accessing contact information stored in the memory; filter the one or more communications based on a prioritization level determined at least in part by information acquired when accessing the contact information; and notify a user of the communication device of the filtered one or more communications by displaying one or more customized images on the indicator area of the display, with a customized image of the one or more customized images being representative of the sender such that the one or more customized images visually overlap with an icon corresponding to the one or more applications.

In still another embodiment, there is a non-transitory computer-readable medium storing computer instructions for displaying a notification on a communication device, that when executed by one or more processors, cause the one or more processors to perform the steps of receiving one or more communications associated with a respective one or more applications operating on the communication device; identifying one or more senders corresponding to the one or more communications by accessing contact information stored in storage and accessible by the communication device; filtering the one or more communications based on a prioritization level determined at least in part by information acquired when accessing the contact information; and notifying a user of the communication device of the filtered one or more communications by displaying one or more customized images on a display of the communication device, with a customized image of the one or more customized images being representative of the sender such that the one or more customized images visually overlap with an icon corresponding to the one or more applications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 illustrates a communication system as an environment in which the present technology may be employed.

FIG. 2 illustrates a mobile communication device in which embodiments of the disclosed technology may be employed.

FIGS. 3A-3E illustrate various embodiments of an indicator displayed on a communications device.

FIG. 4 illustrates an embodiments of indicators displayed in an application of a communications device.

FIGS. 5A-5C illustrate flow diagrams for displaying a notification in accordance with the disclosed technology.

FIG. 6 illustrates a block diagram of a social networking system in accordance with the disclosed technology.

FIG. 7 illustrates a block diagram of a network system that can be used to implement various embodiments.

### DETAILED DESCRIPTION

The disclosure relates to technology for displaying a notification on a communication device. A communication device receives communications, for example email messages, text or picture messages, social media messages or the like, that are associated with a program or application operating on the communication device. For example, a user may have an email application operating on their device that receives communications from senders of other communication devices. When a communication arrives at the user's communication device, the sender of the communication is identified, for example, by accessing contact information stored in the communication device or accessible by the communication device. After recognizing or identifying the sender, the communication may be filtered or prioritized based on a variety of factors, including but not limited to, information available in the contact information of the sender, machine learning based on historical information, most recently received communications, etc. A notification is then displayed on the user's communication device as an indicator in the form of a customized image that corresponds to the look and feel of the sender or otherwise identifies the sender. For example, the customized image may be a facial image of the sender, an avatar representing the sender, initials of the sender, name of the sender, nickname, username, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

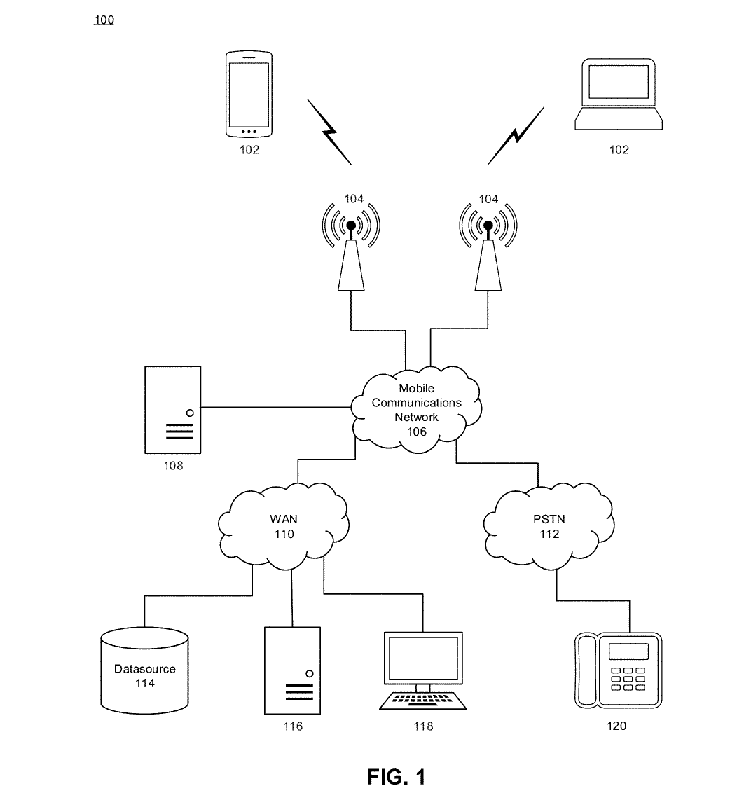

FIG. 1 illustrates a communication system as an environment in which the present technology may be employed. The communication system 100 includes, but is not limited to, communication devices 102, base stations 104, mobile communications network 106, message and notification server 108, wide area network (WAN) 110, public switched telephone network (PSTN) 112, datasource 114, WAN server 116, client 118 and telephone 120.

The communication devices 102 may be connected to a mobile telecommunications network 106 through RF links via respective base stations 104. The mobile telecommunications network 106 may be any commercially available mobile telecommunications system, such as but not limited to GSM, UMTS, LTE, CDMA, or 3G-5G telecommunications systems. The communication devices 102 are illustrated as mobile (cellular) telephones or terminals but may alternatively be other kinds of portable devices, such as portable digital assistants (PDAs), laptops, smart phones, tablets, head mounted displays (HMDs) or the like.

The PSTN 112 is connected, for example, to the mobile telecommunications network 106 such that telephone terminals 120 may be connected thereto.

The mobile telecommunications network 106 is connected to WAN 110, such as the Internet. The WAN 110 may be connected to a WAN server 116, a datasource 114 and to a client 118.

The mobile telecommunications network 106 is provided with a message and notification center 108. Users of the mobile terminals 100 may send and receive messages and notifications from the message and notification center 108 over the radio links. In one embodiment, the messaging and notification of the mobile telecommunications network 106 is employed, allowing users and clients to receive messages and corresponding notifications, as explained further below.

Various communications services such as voice calls, data calls, facsimile transmissions, music transmissions, still image transmissions, video transmissions, electronic message transmissions and electronic commerce may be performed between different communication devices, such as terminals 100, computer 118 and telephone 120 (mobile or otherwise). Among the services provided are alert and notification message transmissions in the form of, for example, short messaging service (SMS) messages multimedia messaging service (MMS) messages, voice messages and email messages, as well as any type of message that may be or form a notification, indicator, badge, alert or display.

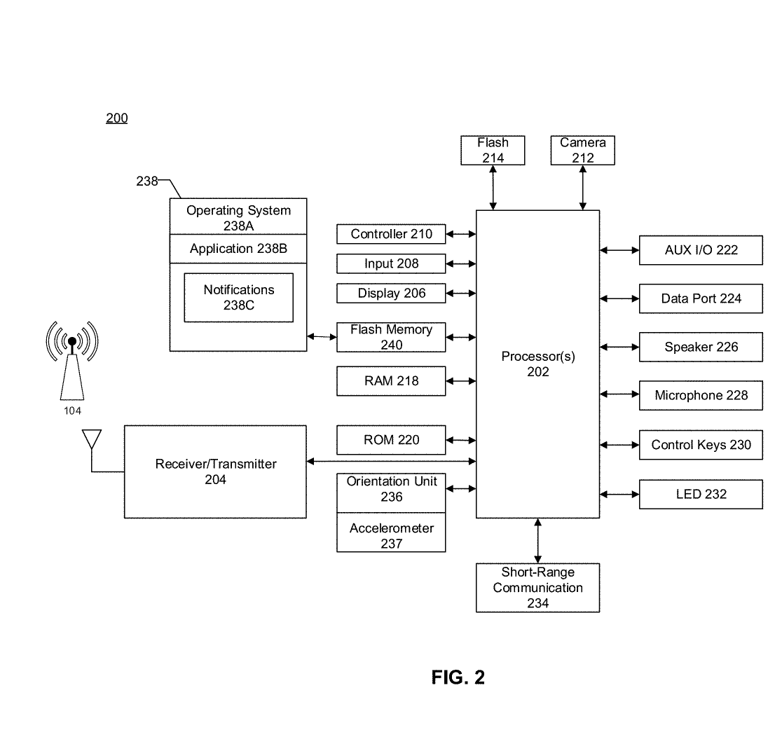

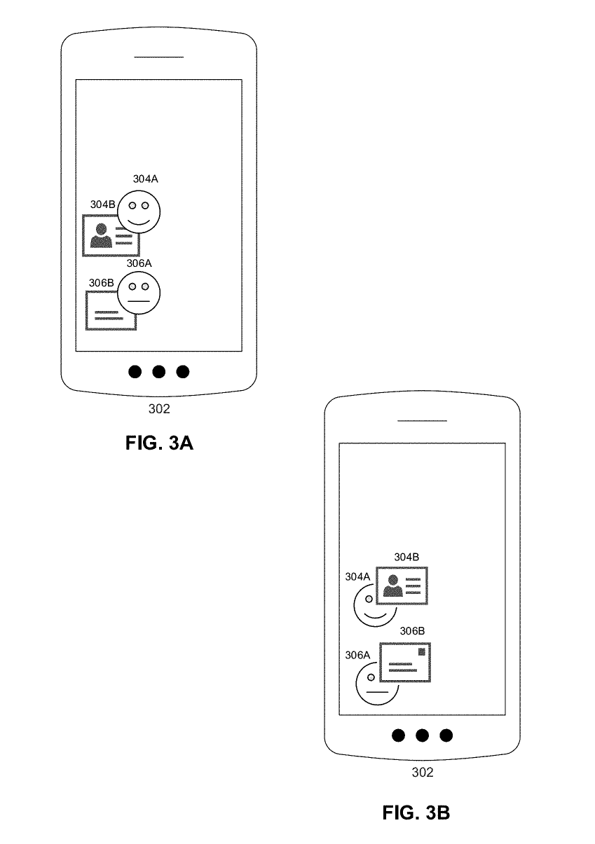

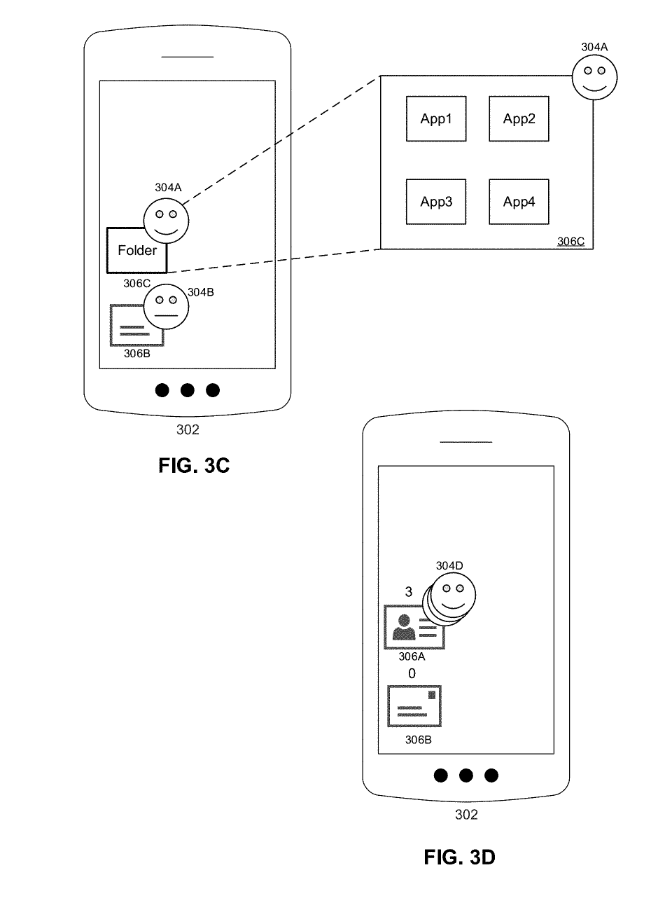

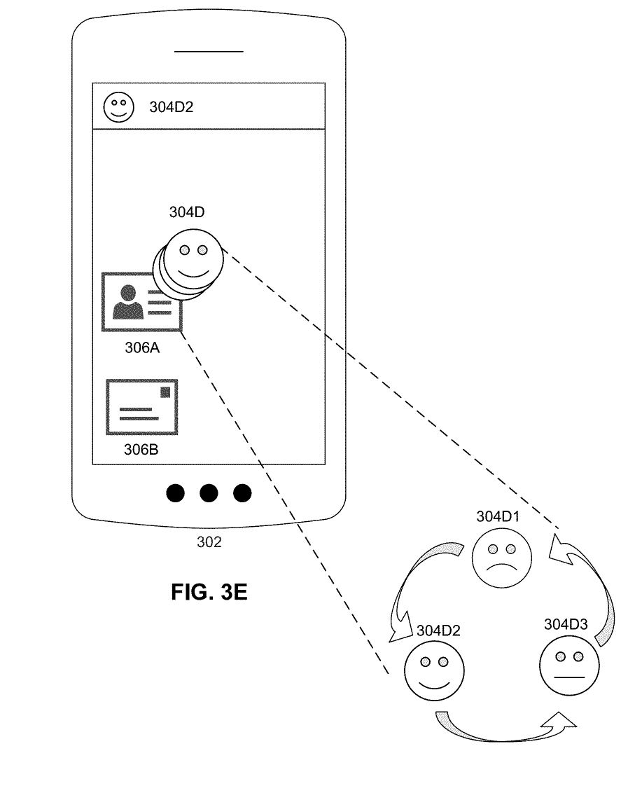

FIG. 2 illustrates a mobile communication device 200 in which embodiments of the disclosed technology may be employed. The mobile communication device 200 in FIG. 2 may be, for example, the mobile communication device depicted in FIGS. 1 and 3A-3E, but is not limited thereto.

In one embodiment, the mobile communication device 200 is a two-way communication device having data and voice communication capabilities and the ability to communicate with other computer systems, for example, via the Internet. The mobile communication device 200 may be configured as a computer, smartphone, a mobile telephone, a tablet style-computer or a PDA (personal digital assistant) enabled for wireless communication, a computer system with a wireless modem or similar.

The mobile communication device 200 may include, but is not limited to, a controller comprising processor(s) 202 such as a microprocessor which controls the overall operation of the mobile communication device 200, and a communication subsystem 204 for exchanging radio frequency signals with the wireless network 104. The communication subsystem 204 in some embodiments comprises one or both of a transmitter and a receiver. The processor(s) 202 interacts with the receiver/transmitter (transceiver) 204, which performs communication functions. The processor(s) 202 also interacts with additional device subsystems including a display screen 206, such as a liquid crystal display (LCD) screen, with a touch-sensitive input surface 208 connected to an electronic controller 210 (together forming a touchscreen display). The mobile communicating device 200 may also include other input and/or output devices, such as a keyboard or mouse.

The processor(s) 202 also communicates with a camera 212 and camera flash 214, flash memory 216, random access memory (RAM) 218, read only memory (ROM) 220, auxiliary input/output (I/O) 222, data port 224, speaker 226, microphone 228, control keys 230, light emitting diode (LED) 232, short-range communication 234, an orientation unit 236, and accelerometer 237.

In one embodiment, the mobile communication device 200 communicates with base stations 104 of the communication system 100. In this context, the mobile communication device 200 may send and receive communication signals over the communication system 100.

The processor(s) 202 executes instructions stored as software instructions 238 in memory, such as the flash memory 240. As illustrated, the software instructions 238 comprise operating system software 238A and software applications 238B. A notifications 238C provides instructions for the processor(s) 202 to operate the notification message function(s) described herein. For example, upon receipt of a message at the mobile communication device 200, the notifications 238C will issue a notification to the display screen 206. Notifications 238C may, among other things, be implemented through standalone software applications, or combined together in one or more of the operating system 238 or other software applications 238B.

Software instructions 238 (or parts thereof) may be stored into volatile memory, such as the RAM 218. The software applications 238B may include a range of applications, including, for example, an address book application, a messaging application, a calendar application, and/or social media applications. In other embodiments, the software applications 238B include an email message application and text messaging applications. Each of the software applications 238B may include layout information defining the placement of particular fields and graphic elements (e.g. text fields, image fields, icons, notifications, alerts, badges etc.) in the user interface (i.e. the display screen 204) according to the application.

In data communication mode, a received data signal, such as a text message, an email message, or social media message, will be processed by the receiver/transmitter 204 and processed by processor(s) 202. For example, an email message may be processed by an email message application and output to the display 206. Similarly, messages may be composed and transmitted by the receiver/transmitter 204.

In the voice communication mode, the mobile communication device 200 provides telephony functions and operates as a typical cellular phone. The overall operation is similar, except that the received signals are output to the speaker 226 and signals for transmission are generated via the microphone 228. The display 206 may also be used to provide an indication of the identity of a calling party or other voice call related information, such as displaying an indication or alert when a call is missed or a voice mail is recorded.

The orientation unit 236 comprises at least one sensor which is coupled to the processor(s) 202 and which is controlled by one or a combination of a monitoring circuit and operating software. The sensor has a sensing element which detects acceleration from motion and/or gravity. The accelerometer 237 may be utilized to detect acceleration of the portable electronic device 200, such as a direction of gravitational forces or gravity-induced reaction forces. Other types of motion sensors may be used by the orientation unit 236 in addition to, or instead of, an accelerometer as appreciated by one skilled in the art.

FIGS. 3A-3E illustrate various embodiments of an indicator displayed on a communications device. With reference to FIGS. 3A and 3B, communications device 302, such as a smartphone, receives communications in a variety of forms from a network, such as network 106 (FIG. 1). Once the communication is received, the operating system 238A (FIG. 2) of the communication device 302 is able to parse the communication and determine an associated program or application. The operating system of the communication device 302 will then be able to launch the associated program or application and establish an association or link to the communication when received.

The communications device 302 in the illustrated examples display a notification as indicators 304A and 306A overlapping an associated program or application icon 304B and 306B. In the case of FIG. 3A, the indicators 304A and 306A overlay the icons of the associated program or application 304B and 306B. In the case of FIG. 3B, the indicators 304A and 306A underlay the icons of the associated program or application 304B and 306B. It is also appreciated that the indicators 304A and 306A could appear alone as the means of notification without displaying the associated program or application icon 304A and 306B, or adjacent or next to the program or application icon 304A and 306B. Moreover, there is no limitation on the degree of overlap. That is, the indicators 304A and 304B may overlap the associated program or application 304B and 306B more or less than depicted.

As noted above, the types of communications include, but are not limited to, email messages, text or short message service (SMS) messages, multimedia messaging service (MMS) messages, social media messages, voice messages, picture images, video messages and the like. In one embodiment, the communications may be received from message and notification server 106. In other embodiments, the communication may be from a communication device 302. However, it is appreciated that communications may be received by the communications device 302 in any manner well understood by the skilled artisan.

In one embodiment, the layout of the indicators 304A and 306A and associated program or applications 304B and 306B may be modified according to a user's preference. The user may create a layout for the display, as well as identify various attributes to associate with the layout. For example, the preferences may include how many communications to display at once, how long to display a notification, what types of notifications to display (e.g., communications from important or favorite contacts), etc. Furthermore, the user preferences may include the types of the messages, selection of the messages specified to some software programs, and message or notification illustrated by image-only, text-only, or in combination with a variety of illustrations.

Opening communications once a notification has been received may include, but is not limited to, tapping the indicator 304A and 306A and/or icon, swiping the indicator 304A and 306A and/or icon 304B and 306B, providing a voice command to open the communication associated with a particular indicator 304A and 306A, or automatically upon arrival of the communication. Additionally, upon opening or reading the communication, the indicator 304A and 306A may be removed, may disappear, or may be re-prioritized.

With reference to FIGS. 3C and 3D, additional embodiments for displaying notifications are illustrated. FIG. 3C illustrates a display of communication device 302 in which a communication has been received for a program or application App1, App2, App3 or App4 in folder 306C. In this case, the indicator 304A is displayed as an overlay to folder 306C as opposed to the program of application App1, App2, App3 or App4. Although the indicator 306C is shown as overlaying the folder 306C, the indicator 304A may also be displayed as overlaying on any one of the associated programs or applications App1, App2, App3 or App4. Moreover, the indicator 304A may appear similar to the embodiments described above with respect to FIGS. 3A and 3B.

FIG. 3D illustrates and example of multiple indicators (or a group of indicators) 304D that are displayed on the communication device 302 so as to overlay an icon 306A of a program or application. In addition to the indicator 304D, a numerical representation of the number of indicators 304D, corresponding to the number of communications received or not read, may also be displayed (similar to conventional notifications). In one embodiment, if the number of communications is zero, then no indicator may be displayed. It is also appreciated that the group of indicators 304D may be displayed in a manner similar to the various embodiments described above and that the illustration is a non-limiting example.

Icon 306B of a program or application is displayed without any currently received communications. Accordingly, no indicator is displayed or associated with the program or application other than the number zero being displayed as a numerical indicator. In one embodiment, if the number of communications is zero, then no indicator may be displayed. It is appreciated that the numerical indicator need not be displayed and is intended as one example.

In one embodiment, the group of indicators 304D may include notifications for individual communications for which the senders are unrelated. In another embodiment, the group of indicators 304D may be based on a categorization. For example, the communications displayed in the group of indicators 304D may be related to a group of friends, a group of family members or communications related to work or a professional society. In the context of categorization, a notification will only be displayed if the communication falls within the requirements of the categorization. Moreover, the group of indicators may be prioritized as explained below with reference to FIG. 3E.

In FIG. 3E, the group of indicators 304D is illustrated as being rotatably displayed on the communication device. That is, each of the indicators 304D1, 304D2 and 304D3 in the group of indicators 304D will be displayed in a rotating manner as a visual overlay to the associated program or application 306A. In one embodiment, the indicators 304D1, 304D2 and 304D3 in the group of indicators 304D are rotated based on display time. In another embodiment, the indicators 304D1, 304D2 and 304D3 in the group of indicators 304D are rotated based on priority. As a particular one of the indicators 304D1, 304D2 and 304D3 is opened or expires, the particular indicator may be removed from the rotation. Additionally, indicators may be added to the rotation as new communications are received by the communications device 302.

In one embodiment, one or more of the indicators 304D1, 304D2 and 304D3 may additionally or in lieu of be displayed in the status bar of an interface on the display of the communication device 302. Indicators appearing in the status bar, such as indicator 304D2, may be statically displayed or dynamically displayed so as to rotate or be animated. Although a single indicator is displayed in the example of FIG. 3E, any one or more of the indicators may be displayed. Moreover, the status bar need not appear at the top of the interface of the display, but may located in any position within the display as appreciated by the skilled artisan.

As noted above, indicators may be displayed based on priorities. The priorities may be determined based on numerous factors including, but not limited to, subject, date, time, identity of the sender, categorization (e.g., favorite or important contact), machine learning, historical information, etc. The level of the priority may be attached to the communication or determined by accessing storage or a database of contact information.

In one embodiment, the communication device 302 may sort incoming communications based on the priority by displaying higher priority communications to the user first. By providing sorting and filtering of communications based on priority, the communication device 302 allows the user to focus on higher priority communications prior to other, less important communications. In one embodiment, the user can turn off the priority based sorting and filtering.

In another embodiment, displayed indicators 304D1, 304D2 and 304D3 may be displayed in a variety of forms and types. For example, the indicators 304D1, 304D2 and 304D3 may be displayed in color, black and white, grayscale, and as a visual or audio indicator, such as a customized image. For example, the image may be a stock photo, a personal photo (e.g., a head shot or face), an avatar, a picture, initials, a name, etc.

As illustrated in FIG. 3E, the communications device 302 is displaying two application icons 306A and 306B. In the example of FIG. 3E, icon 306A is an application contact icon and icon 306B is an application email icon. The applications may receive a notification as a result of an incoming communication that results in the notification(s) (e.g., indicators, icons, alerts, badges, etc.) to be displayed. As discussed above, the indicators associated with the program or application receiving the communication may be displayed in different locations relative to their corresponding application icons. In the depicted example, the indicators 304D1, 304D2 and 304D3 are images that overlap the corresponding program or application icon 306A.

In one embodiment, and similar to FIG. 3D, indicators 304D1, 304D2 and 304D3 may be a combination of an image with a numeric value that represents the number of communications. For example, for a program or application associated with the contact icon 306A of address book contacts, the indicators 304D may represent the number of unread or new communications from contacts in the address book.

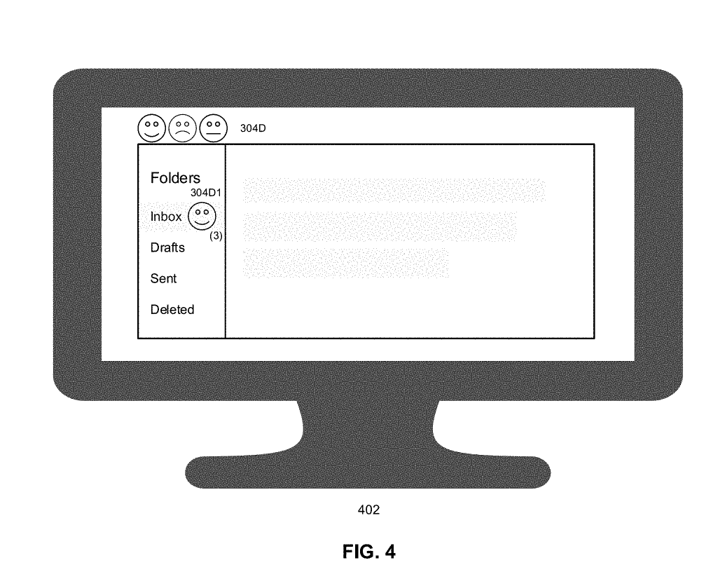

FIG. 4 illustrates an embodiment of indicators displayed in an application of a communications device. In the example of FIG. 4, an email application is operating on a communication device 402, such as a computer. As appreciated, the application is not limited to an email application, but may be any application operating on the computer. Moreover, the communication device is not limited to a computer, but may be any communication device as described herein.

As communications are received, computer 402 displays indicators 304D in the status bar, along with indicator 304D1 notifying the user of incoming email. As depicted, the inbox has received three (3) new communications (e.g., email messages) from senders associated with indicators 304D. In the example, indicator 304D1 may be the most recently received communication. However, similar to the above described embodiments, the indicators 304D may be visually displayed in a rotating manner, or in any other manner as discussed herein.

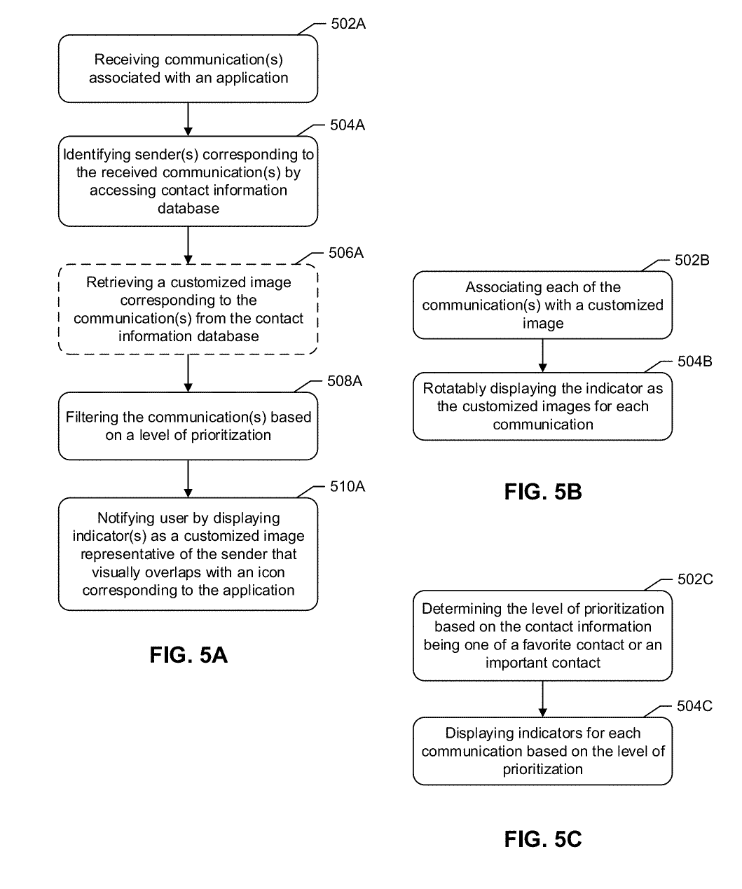

FIGS. 5A-5C illustrate flow diagrams for displaying a notification in accordance with the disclosed technology. In the discussion of FIGS. 5A-5C, the processes are implemented using processor(s) 202 of the communication device 200, along with the corresponding components (FIG. 2). However, it is appreciated that the disclosed embodiments are not limited to such implementation and that any system component may be responsible for such implementation.

At 502A, and with reference to FIG. 5A, a communication device, such as communications device 200, receives a communication from another communication device 200 (and/or via notification and message server 108). When the communication is received, the processor(s) 202 of the communication device 200 associates the communication with an application residing on the communications device 200. For example, if the communication is an email message, the communication is associated with an email application. If the communication is a social media message, then the communication is associated with a social media application.

The processor(s) 202 then identifies a sender of the communication. The processor(s) 202 may identify the sender using a variety of methods at 504A. For example, the communication may include an identifying value or tag that the processor(s) 202 may access to identify the sender of the communication. In another example, the processor(s) 202 may access a database or storage that stores, for example, electronic address books or contact information to identify the sender of the communication (it is appreciated that the storage or database may be part of the communication device or at a remote location (e.g., in the “cloud”) accessible by the communication device). In one embodiment, the information in the communication, for example, an email address, may be associated with an individual name or entity stored in the address book or contact information database.

Optionally, at 506A, a customized image corresponding to the contact information of the identified sender may be retrieved by the processor(s) 202 from storage. As explained above, the customized image may be a face image, avatar, name, initials or other identifying information of the sender for display as a notification indicator. In alternative embodiments, the customized image may be received as part of the communication or received as an independent communication after identification of the sender.

As communications are received and notifications displayed at the communication device 200, the communications may be filtered or sorted at 508A according to a variety of factors, including the various method of prioritization described above. Some notable means of prioritization include, but are not limited to, the time of arrival of the communication, sorting the communications by sender name, filtering based on important or favorite contacts, filtering by machine learning and the like. In one embodiment, the prioritization is handled by the communication device 200. In another example, the prioritization is handled by a component in communication system 100, such as message and notification server 108 or internet server 116.

The user is notified by the communication device 200 at 510A. The notification may be displayed as an indicator to notify the user of an incoming or received communication, such as a text message. The indicator, which may be displayed in an indicator area of the display, may be in the form of a customized image, such as a face image or avatar representing the sender. In one embodiment, the customized image may be animated and/or provide an audible signal, tune or music. In another embodiment, the customized image may cause the communication device 200 to vibrate with the notification. It is also appreciated that any combination of the aforementioned notifications may be employed.

The indicator, as displayed on the communication device 200, may visually overlap an icon that corresponds to the application. For example, the communication may be an email message associated with an email application, which application has an associated icon. The indicator may then be displayed as an underlay or overlay (overlap with) the icon of the application, as depicted for example in FIGS. 3A-3E.

Turning to FIG. 5B, at 502B, the processor(s) 202 associates incoming communications with a customized image. In addition to or in lieu of statically displaying the indicator as a single customized image, multiple indicators may be displayed. In one embodiment, at 504B, the multiple indicators are displayed side-by-side, top-to-bottom, or cascaded. In another embodiment, the multiple indicators are rotatably displayed such that at least one of the indicators is predominantly displayed. In still other embodiments, the indicators flash, change colors, change images, have a raised surface, or may be modified in any manner to provide notification.

With reference to FIG. 5C, a prioritization level is determined at 502C. The prioritization level may be based, for example, on the contact information specifying that the contact (in this case, the sender of the communication) is identified as a favorite or important. At 504C, the indicators may be displayed based on the determined level of priority. Moreover, prioritization may be based on any of the factors described herein.

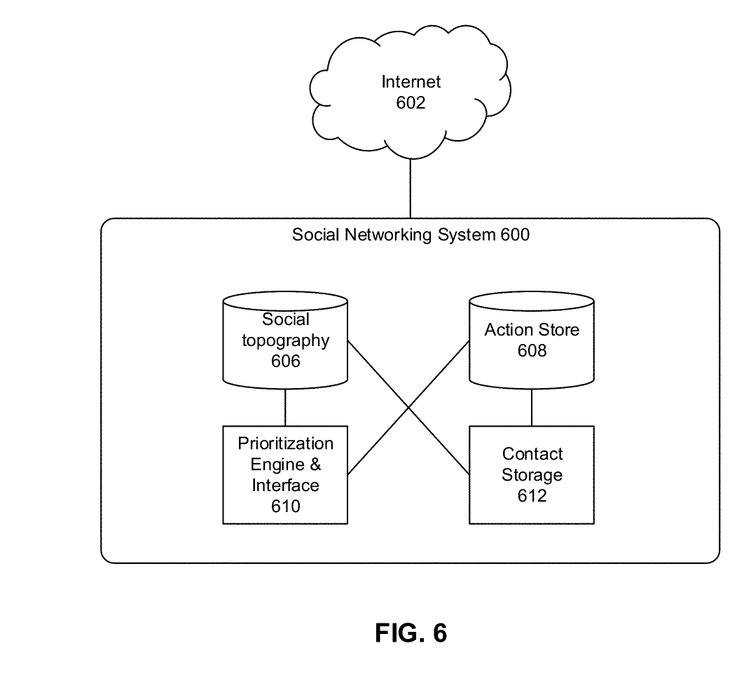

FIG. 6 illustrates a block diagram of a social networking system in accordance with the disclosed technology. The social networking system 600 is communicatively coupled to a communication device 102 (see FIG. 1) and the Internet 602 (or other network), and includes, but is not limited to, a social topography 606, action store 608, prioritization and interface engine 610, and contact storage 612.

The social topography 606 stores the connections that each user has with other users of the social networking system 600. The connections may be direct or indirect connections. For example, if user1 is a first-order connection of user2 but not of user3, and user 2 is a first-order connection of user3, then user3 is a second-order connection of user1 on the social topography 606.

The action store 608 stores actions that have been performed by the users of the social networking system 600. In one embodiment, the action store 608 may contain the number of posts by a user to a social media website, messages sent by the user, a number of photos posted by the user, etc. For a given connection between two users, user1 and user2, the action store 608 may contain actions such as the number of profile page views from user1 to user2, the number of photo page views from user1 to user2, the number of messages from user1 to user2, and the number of times user1 and user2 were tagged in the same photo. Any of these actions may cause the social network system 600 to create or generate a notification to a user or user account, for example, in a manner similar to the notifications depicted in FIGS. 3A-3E and 4.

The prioritization engine and interface 610 provides a user interface for the user to review and prioritize incoming messages. The user interface, for example the display on a communication device 102 (FIG. 1), displays priority indications for the incoming messages in accordance with various embodiments of the technology. For example, the indications illustrated in FIGS. 3A-3E and 4 may be displayed according to priority and as described above.

In one embodiment, the prioritization engine and interface 610 may determine an overall priority for the message. This overall priority may be an identifier or a score (e.g., high priority or normal priority) or one of predefined values (e.g., high, medium, or low priority) or range of values (e.g., a score from 0 to 1, where 0 is the lowest priority, 1 is the highest priority, and 0.5 would be approximately average priority). Other embodiments include prioritizing messages as defined in a contact storage 612, retrieved from favorites in the contact storage 612, manual ranking or learned from machine learning, using for example historical prioritization data. Factors may include the status of a message, such as read or unread messages, sender priority, social weight as determined by the social networking system 600, etc. The user can also configure the settings of prioritization. Accordingly, the user may view or edit the priority settings.

In another embodiment, messages may also be dynamically prioritized based on recent user activity. For example, a message may be prioritized with an initial priority when it is first received and associated with a different priority each time it is presented to the user depending on when the user views the message and the recent activity of the user. This allows for messages that are currently important, urgent, or relevant to the user to be prioritized higher.

Contact storage 612 includes, for example, an electronic address book for storing entries, where each entry may store corresponding contact information. For example, each entry of an electronic address book may store a contact's name, address, phone number, fax number, and email address, among other data. Similarly, the contact storage 612 may be responsible for keeping track of peers and friends contact information related to social media websites and/or third party applications. For example, contact storage 612 may be responsible for storing information related to a colleague indicating a change of jobs or moving to another geographic location, such that the contact storage updates the relevant contact information. This information may also be used by the prioritization engine and interface 610, for example, to assist or update prioritization of incoming messages.

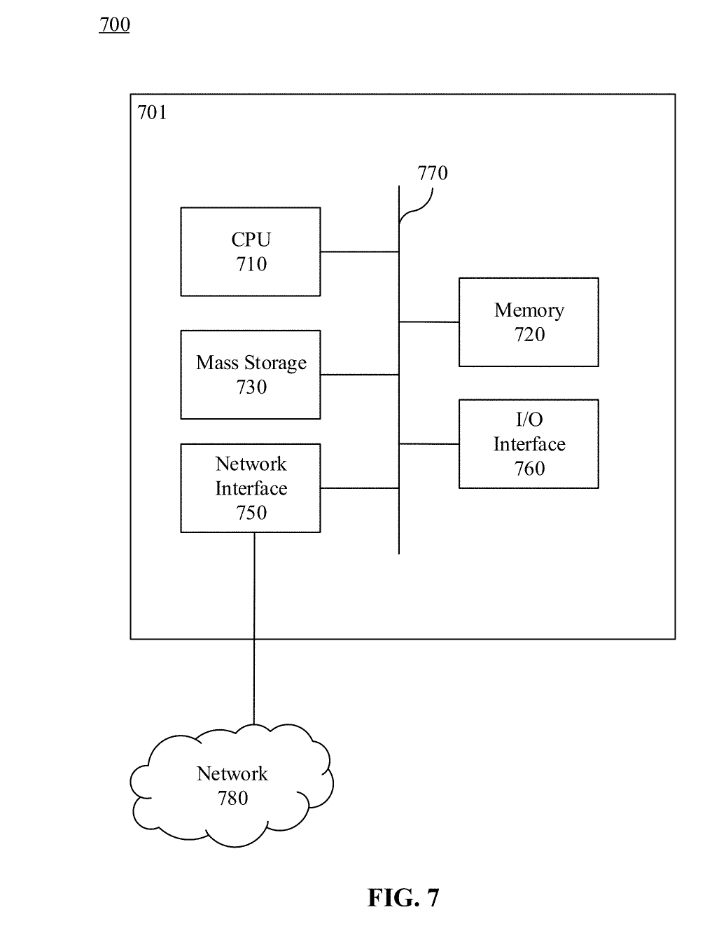

FIG. 7 is a block diagram of a network system that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system 700 may comprise a processing unit 701 equipped with one or more input/output devices, such as network interfaces, storage interfaces, and the like. The processing unit 701 may include a central processing unit (CPU) 710, a memory 720, a mass storage device 730, and an I/O interface 760, with the components connected to a bus 770. The bus 770 may be one or more of any type of several bus architectures including a memory bus or memory controller, a peripheral bus, or the like.

The CPU 710 may comprise any type of electronic data processor. The memory 720 may comprise any type of system memory such as static random access memory (SRAM), dynamic random access memory (DRAM), synchronous DRAM (SDRAM), read-only memory (ROM), a combination thereof, or the like. In an embodiment, the memory 720 may include ROM for use at boot-up, and DRAM for program and data storage for use while executing programs. In embodiments, the memory 720 is non-transitory. The mass storage device 730 may comprise any type of storage device configured to store data, programs, and other information and to make the data, programs, and other information accessible via the bus. The mass storage device 730 may comprise, for example, one or more of a solid state drive, hard disk drive, a magnetic disk drive, an optical disk drive, or the like.

The processing unit 701 also includes one or more network interfaces 750, which may comprise wired links, such as an Ethernet cable or the like, and/or wireless links to access nodes or one or more networks 780. The network interface 750 allows the processing unit 701 to communicate with remote units via the one or more networks 780. For example, the network interface 750 may provide wireless communication via one or more transmitters/transmit antennas and one or more receivers/receive antennas. In an embodiment, the processing unit 701 is coupled to a local-area network or a wide-area network for data processing and communications with remote devices, such as other processing units, the Internet, remote storage facilities, or the like.

The disclosed technology may provide the following advantages: a face indicator of favorite/important contacts to filter out noise and tracking progress of reading that flexibly combines other notifications according to user preference, help to focus on important communications and increase efficiency and life quality within social era communication much noise, introduces customized images into internal design of applications, e.g. WeChat™ and Outlook™, to avoid red dot disturbance caused by general notifications.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for displaying a notification on a communication device, comprising:
receiving one or more communications associated with a respective one or more applications operating on the communication device;
identifying one or more senders corresponding to the one or more communications by accessing contact information stored in storage and accessible by the communication device;
filtering the one or more communications based on a prioritization level determined at least in part by information acquired when accessing the contact information; and
notifying a user of the communication device of the filtered one or more communications by displaying one or more customized images on a display of the communication device, with a customized image of the one or more customized images being representative of the sender such that the one or more customized images visually overlap with an icon corresponding to the one or more applications.

2. The method of claim 1, wherein the icon is located within a folder being displayed on the display and the one or more customized images visually overlap with the folder.

3. The method of claim 1, wherein the customized image is one or more of a face image, avatar, name, initials, nickname, or username of the sender of the communication.

4. The method of claim 1, wherein
each of the one or more communications is associated with a customized image, and
the customized images rotatably displayed.

5. The method of claim 1, wherein the one or more customized images are displayed adjacent to one of a numerical value and a message indicator.

6. The method of claim 1, wherein the customized image expires after a predetermined amount of time.

7. The method of claim 1, wherein the customized image disappears when the communication is accessed by the user.

8. The method of claim 1, wherein the customized image is retrieved from the contact information and is one of a favorite contact or an important contact.

9. The method of claim 1, wherein the communication is at least one of an email message, a multimedia messaging service (MMS) message, or an application notification.

10. The method of claim 1, wherein the customized image is animated.

11. The method of claim 1, wherein the customized image is displayed in a status bar of the display.

12. The method of claim 1, wherein the one or more customized images are displayed for each of the one or more communications based on the prioritization level.

13. The method of claim 12, wherein the prioritization level is based on the contact information comprising one of the favorite contact or the important contact.

14. A communication device, comprising:
a non-transitory memory storage comprising instructions;
a transceiver to receive one or more communications associated with a respective one or more applications operating on the communication device;
a display including an indicator area notifying a user of the communication device when the one or more communications is received; and
one or more processors in communication with the memory, the transceiver, and the display, wherein the one or more processors execute the instructions to:
identify one or more senders corresponding to the one or more communications by accessing contact information stored in the memory;
filter the one or more communications based on a prioritization level determined at least in part by information acquired when accessing the contact information; and
notify a user of the communication device of the filtered one or more communications by displaying one or more customized images on the indicator area of the display, with a customized image of the one or more customized images being representative of the sender such that the one or more customized images visually overlap with an icon corresponding to the one or more applications.

15. The communication device of claim 14, wherein the icon is located within a folder being displayed on the display and the one or more customized images visually overlap with the folder.

16. The communication device of claim 14, wherein the customized image is one or more of a face image, avatar, name, initials, nickname, or username of the sender of the communication.

17. The communication device of claim 14, wherein
each of the more than one communications is associated with a customized image, and
the customized images rotatably displayed.

18. The communication device of claim 14, wherein the one or more customized images are displayed adjacent to one of a numerical value or a message indicator.

19. The communication device of claim 14, wherein the customized image is retrieved from the contact information and is one of a favorite contact or an important contact.

20. A non-transitory computer-readable medium storing computer instructions for displaying a notification on a communication device, that when executed by one or more processors, cause the one or more processors to perform the steps of:
receiving one or more communications associated with a respective one or more applications operating on the communication device;
identifying one or more senders corresponding to the one or more communications by accessing contact information stored in storage and accessible by the communication device;
filtering the one or more communications based on a prioritization level determined at least in part by information acquired when accessing the contact information; and
notifying a user of the communication device of the filtered one or more communications by displaying one or more customized images on a display of the communication device, with a customized image of the one or more customized images being representative of the sender such that the one or more customized images visually overlap with an icon corresponding to the one or more applications.

21. The non-transitory computer-readable medium of claim 20, wherein the customized image is retrieved from the contact information and is one of a favorite contact or an important contact.

22. The non-transitory computer-readable medium of claim 20, wherein the customized image is one or more of a face image, avatar, name, initials, nickname, or username of the sender of the communication.
